(19) United States
(12) Patent Application Publication
(10) Pub. No.: US 2014/0310198 A1
(43) Pub. Date: Oct. 16, 2014

(54) METHOD AND SYSTEM FOR EMPLOYEE AND CLIENT ENGAGEMENT

(71) Applicants: Tom Wamberg, Naples, FL (US); Charles J. French, Chicago, IL (US); George F. McNulty, Robbinsdale, MN (US)

(72) Inventors: Tom Wamberg, Naples, FL (US); Charles J. French, Chicago, IL (US); George F. McNulty, Robbinsdale, MN (US)

(21) Appl. No.: 14/212,122

(22) Filed: Mar. 14, 2014

Related U.S. Application Data
(60) Provisional application No. 61/798,168, filed on Mar. 15, 2013.

(51) Int. Cl. G06Q 10/10

(52) U.S. Cl. CPC G06Q 10/10
USPC 705/345

(57) ABSTRACT

A platform and method for employer/employee communications having controlled channels where the employee receives personalized, targeted and filtered communications. The employee is able to access content and data visualized information as well as broadened accounting performance data or key performance indicators (KPI), such as relative value units and quality measures. The improved platform further provides a concierge-level technological functionality for professionals which delivers up-to-date industry content on a consolidated dashboard that will be attractive to busy participants, such as business executives and physicians. An experienced service liaison function will also absorb employee requests, provide assistance, and reduce the volume of contacts to in-house resources. The menu-driven platform administers services along with providing a connection to third party content, data and service providers. The present system can serve as a content aggregator for the user. In addition, the system provides its users with audit, tracking and logging capabilities so that the user can easily compile information and thus benefit from the efficiencies inherent in consolidated reporting.

### CROSS REFERENCE TO RELATED APPLICATION

This application claims priority under 35 U.S.C. §119(e) to U.S. provisional patent application 61/798,168, filed on Mar. 15, 2013, which is hereby incorporated by reference in its entirety.

### FIELD OF THE INVENTION

A platform and method for employer/employee communications having controlled channels where the employee receives personalized, targeted and filtered communications. The employee is able to access content and data visualized information as well as broadened accounting performance data or key performance indicators (KPI), such as relative value units and quality measures. The improved platform further provides a concierge-level technological functionality for professionals which delivers up-to-date industry content on a consolidated dashboard that will be attractive to busy participants, such as business executives and physicians. An experienced service liaison function will also absorb employee requests, provide assistance, and reduce the volume of contacts to in-house resources. The menu-driven platform administers services along with providing a connection to third party content, data and service providers. The present system can serve as a content aggregator for the user. In addition, the system provides its users with audit, tracking and logging capabilities so that the user can easily compile information and thus benefit from the efficiencies inherent in consolidated reporting.

### BACKGROUND OF THE INVENTION

In most businesses, it is becoming increasingly important for employers to engage with employees. These engagements can positively impact employee performance and lead to enhanced innovation, increased productivity and improved efficiency. With increased centralization of data in various web related environments, such as cloud based models, the drive for improved technological engagement with employees across industries is an important and achievable goal. Moreover, improved efficiencies and flexibility of communications technologies evidenced by the myriad social networking ecosystems increases employer-employee engagement opportunities. Finally, the ubiquity of communications hardware including the iPad and other tablets, smart phones, smart readers, laptops forms a “perfect storm” of opportunities for employer, colleague and employees to engage in a sophisticated, efficient and multi-level fashion.

In medicine the need for such technological forms of engagement is critical. There are significant advantages for hospitals and other employers in medicine to engage with employees. Those advantages include improved doctor retention, improved patient communication improved access to and control of information, improved satisfaction, and improved clinical results. An engaged and informed care provider will ultimately improve patient safety, quality of care delivery and gain expanded business opportunities as the reputation of the practice flourishes. In the article “What the Doctor Ordered”, appearing in the Gallup Business Journal, for example, improved physician engagement was linked to better on the job behavior and financial performance of the hospital per adjusted admission.

Improved physician engagement also helps avoid many of the pitfalls in medicine. For example, physicians are becoming increasingly difficult to recruit. In a 2012 survey by Merrit Hawkins (published as part of the 2012 the American Association of Medical Colleges Physicians Workforce Policy Recommendations) found that 75% of graduating medical residents received fifty or more job offers during their training. Once recruited, however those physicians were difficult to retain. For example “Kaiser Fights Doctor Turnover”, (published in the San Francisco Business Times (Mar. 11, 2007) reported that many physicians were leaving their job for less demanding work, or cutting back on their work schedule altogether. Another study concluded that 54% of physicians leave their jobs in the first five years (“Physician Shortage Challenges Medical Groups and Increases Demand for Advanced Practitioners.” Mar. 12, 2012. Cejkasearch.com). To recruit a new physician, meanwhile, a hospital can lose as much as $1,000,000 when lost revenue is considered as a factor. (Bryan Warren “Select Perspectives” Commentary on the “Shocking Cost of Physician Turnover” www.selectinternational.com. Aug. 13, 2012.)

While many systems have been developed to improve for example Medical record keeping, patient and tracking clinical outcomes, there is relatively little in the way of systems that are designed to provide improved platforms for employer/employee communications. Specifically, there is a lack of platforms where employees are able to engage with peers and employers in order to access communications organized by areas of specialty. |_{[GFM1]}Moreover, there is relatively little to engage the physician as an employee and as an individual with personal needs.

Further, there is a need for an employer/employee platform where data channels are personalized based on an individual's employment specialty, and filtered so that only collaborators can communicate.

### SUMMARY OF THE INVENTION

Therefore, it is an object of the present invention to provide a platform for employer/employee communications through controlled channels where the employee receives personalized, targeted, filtered communications from a variety of sources. Moreover, the employee is able to access data visualized information as well as broadened accounting performance data, such as relative value units.

A further object of the invention is to provide a concierge-level technological functionality for professionals, including but not limited to medical professional physicians and providers. The present invention also delivers up-to-date industry content along with an easy to use computer-based dashboard that will be attractive to busy participants, such as business executives and physicians. An experienced service liaison function will also absorb benefits questions, provide assistance, and reduce the volume of contacts to in-house human resources. The menu-driven platform of the present invention will be available to administer services as well as provide an engaging platform for third party service providers. The present system can serve as a content aggregator for the provider. In addition, the system provides its users with audit, tracking and logging capabilities so that the user can easily compile information and thus benefit from the efficiencies inherent in consolidated reporting.

One portal of the system will guide an employee through various life events, offering services to assist in both the major and mundane decisions. The present system will reduce the number of tasks by providing personalized information in conjunction with basic information on services offered as well as direct links to service vendors and service liaisons.

The system can be implemented on a number of platforms and embody different architectures. In a preferred embodiment, the system is implemented on a cloud platform that will allow for continuous web access in a secure environment. The user interface is menu-driven, customizable and segregable in order to allow the user to exit an organization and take the portable parts of the program with them. Moreover, the system can be deployed in any employer/employee setting including any business, professional or academic setting. For purposes of non-limiting illustration only, the present invention will be described in the context of a medical environment.

These and other aspects and advantage of the invention will be apparent to one of ordinary skill in the art from the following detailed description of the preferred embodiments and the drawings.

### BRIEF DESCRIPTION OF THE DRAWINGS

FIG. 1 is a block diagram of the functional modules of the present invention;

FIG. 2a is an architectural block diagram of one embodiment of the present invention;

FIG. 2b is an architectural block diagram of a second embodiment of the present invention;

FIG. 3 is a flow diagram of the participant workflow;

FIG. 4a is a flow diagram of the system login process;

FIG. 4b is a flow diagram of a second embodiment of the system login process;

FIG. 5 is a work flow diagram of a service request initiation;

FIG. 6 is a workflow diagram of the onboarding tasks process;

FIG. 7 is a logic flow diagram of the local applications process;

FIG. 8 is a logic flow diagram of the user my account functions;

FIG. 9 is a logic flow diagram of the knowledge base workflow steps;

FIG. 10 is a flow chart of the calendar module;

FIG. 11 is a flow chart of the create ticket workflow;

FIG. 12 is a flow chart of the Take a Survey function;

FIG. 13 is a workflow diagram of the activity management process;

FIG. 14 is a workflow chart of the polls method;

FIG. 15 is a flow diagram of the CME process workflow;

FIG. 16 is a participant workflow diagram of the messaging functionality;

FIG. 17 is a process flow diagram of the internal and external news functions of the present invention;

FIG. 18 is a flow diagram of the topics process steps;

FIG. 19 is a participant workflow diagram of the supplemental benefits functions;

FIG. 20 is a workflow diagram of the KPI reporting functions of the present invention;

FIG. 21 is a flow chart of the Reminders and Notifications functions;

FIG. 22 is a process flow diagram of the administration-application level workflow functions; and

FIG. 23 is an overhead view of the user dashboard of the present invention.

### DETAILED DESCRIPTION

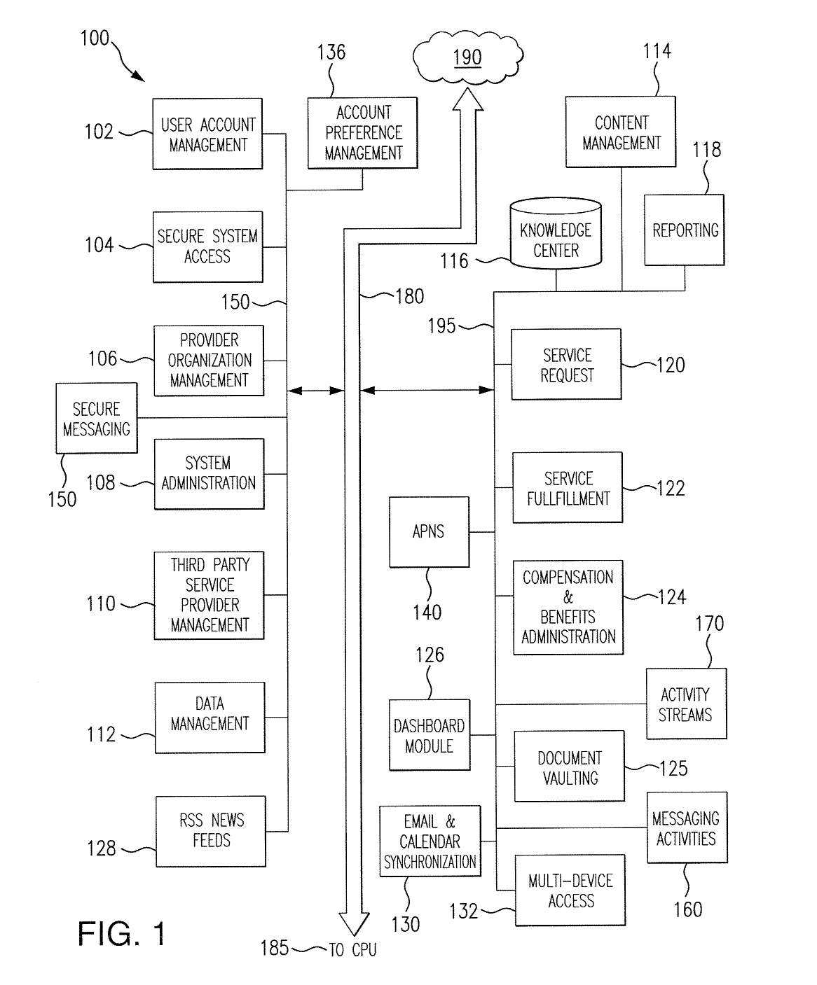

Referring to FIG. 1 wherein like reference numerals refer to like elements, a function block diagram of a first embodiment of the present system 100 is illustrated.

The system 100 includes a user management module 102. As shown the module 102 provides multiple functions directed to engaging users. The functional roles include a system administrator application, a maintenance manager and a provider organization analyst. Additionally, the user management module 102 provides liaison with end users, customers (e.g. employers) as well as with a communications center (for example, a centralized help desk, a service provider call-center, a hospital HR department computer/server). The module 102 enables a system administrator to add and modify users authorized. The user manager module will also manage guest users. For example, the system administrator and application maintenance manager functions add and/or remove guests and registered users and reset their respective passwords. The provider organization analyst, service liaison and contact center liaison functions will be able to assist with system login issues including resetting passwords.

Some system data is restricted and not to be shared with all users. This data may include financial and protected health information. The application maintenance manager will assign each user to a role (such as a project proposer, consulting party) that will determine that user's permissions. A “guest” role (for a spouse/attorney/etc.) can be approved by the user for access to their account.

Other functions performed by the user management module 102 include adding users, modifying user status and related data, assigning user roles, and providing system and data access permissions in accordance with those assigned roles, and modifying same.

The user management module 102 is connected via communications line 150 to a main system linkage 180. This linkage can take the form of a hardwired bus, a wireless capability via a wireless router, or it can form part of a distributed platform connecting multiple separate functions through a variety of different connections. Thus, communication lines 150, 195 and 180 can be implemented as hardware, software or represent virtualized connections between distinguishable functional modules. Processing of the module functions can also be achieved through a variety of platforms, each exhibiting different architectural features. For example, the module 102 can be connected by a bus to a central CPU, such as a hospital server 185 (not shown). Alternatively, some or all of the functions provide by the modules, including the user management module 102, can be executed by one or more servers accessible via the Internet to a single hosted location that remains inside the hospital firewall. In yet another embodiment, processing is handled over the cloud on the Internet as shown by element 190. Alternative system architectures will be illustrated later in other embodiments of the present invention.

In first embodiment 100, the secure system access module 104 requires users of system 100 to login for the first time using a pre-communicated user ID and temporary password. Approval of users by this module is based on rules developed by, for example, a system administrator level individual and may include confirmation of the user's business need for access to system 100. The temporary password will be set, for example, during the user set-up process based on a default set using personal data—such as Moen1234 (first four digits of last name, last four digits of the social security number). Users will be prompted to set up a permanent password and to supply answers to one or more user-defined security questions. Users will also be able to gain access to a forgotten user ID or password by identifying themselves and by answering pre-set security questions.

If a user is unable to login, the system 100 will provide information about contacting the application maintenance manager or service liaison modules, as described above in connection with the user management platform 102.

The system 100 provides an option for e-mailing the application maintenance manager. Once logged-in, a user will be presented with their “home” page, which may differ for each user based on their role. A physician's home page design may differ, for example, then for an administrator, a nurse, or a cafeteria worker or a radiology technician or for other professionals or business executives in other industries. Internal users, when approved, will log on with their lightweight directory access protocol (LDAP) user name and password. Other password and protocol schemes however may be used with the present invention. A user will then be authenticated, such as by an IBM/HTTP type Server (IHS).

The system 100 further includes a provider organization management module 106. This module acts as a gatekeeper for provider organization access to the system 100. This module can also modify provider organization status and add group plans with a provider organization. For example, there may be multiple plans for one provider organization such as an executive plan, a cardiologist plan, or a physician group plan. Further, the provider organization management module 106 can modify group plans, add or delete groups plans associated with a specific provider. Finally, this module 106 can add plan services and modify plan services.

The system administration module 108 coordinates maintaining the servers (e.g. CPU 150), the network (e.g. cloud 190) and the client environment (e.g. dashboard 126). The administration module 108 also manages the database usage process and especially data warehousing through the system 100's internal knowledge center 166, or externally, such as through cloud storage 190. Other data functions performed or coordinated by the system administration module include secure messaging 150, messaging activities 160 and the activity streams 170. These functions will be described in more detail below. The process includes extracting data from outside sources, transforming it to fit operational needs, which can include data quality levels, loading data into the appropriate database and providing users at various security levels with the ability to view, extract, transform and load (ETL) data and data history information, participate in secure messaging, receive individualized alerts, receive accounting and other back-office information and perform search functions.

In first embodiment 100 the system is modeled to have services provided by a number of third parties. In this embodiment, the third party service provider module 110 manages all third party access to the system including the ability to add or modify providers as directed by the system administrator.

The data management module 112 will utilize ETL capabilities to manage data in, for example, the knowledge center 116. Categories of data that will be loaded include user information, provider organization data, provider organization plans, provider organization plan services, participant personal data, participant compensation and benefit data, and third party service provider data.

The system also provides a content management function 114 that administers, creates and modifies content on the portal. The content management function is utilized for both the system 100 and an external provider organization.

The system 100 further includes a knowledge center 116 that assists in providing efficient and data lookup and management services. The system 100 is responsible for a large amount of information that needs to be readily accessible. By use of the knowledge center, the system 100 will be able to create, update, modify, search and distribute knowledge content.

An administrative feature of the system 100 is the reporting module 118. This module tracks and reports on data. The system operations/application maintenance manager, the implementation manager, the provider organization contact and/or a physician are all examples of personnel or entities that are able to build and export/print reports using the reporting module 118.

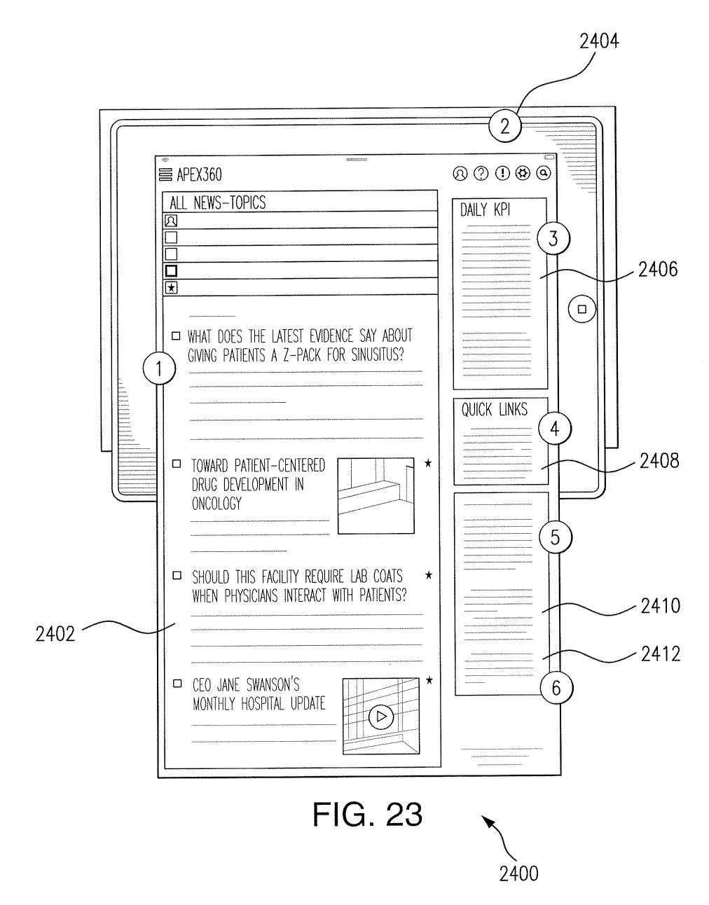

A dashboard module 126, the details of which will be shown in reference to FIG. 23 provides support for the system 100 “home page”. As shown in reference to FIG. 23 the dashboard will be provided by this module with some default setting, features, content as well as customizable options.

The account preferences management module 136 is associated with the dashboard module 126 whereby participants will be allowed to add and modify various services on their respective dashboards. Features and services that can be modified by a user include personal information provided from the user account module 102, and password and set up security information provided from the secure system access module 104.

Service requests to the system 100 are handled by service request module 120 whereby a system user can access web-sites by clicking on a link, by initiating contact with a service liaison via a phone call managed on the dashboard or by an online chat request. As a consequence, the service request module 120 acts as a gateway between the dashboard module 126, and all external services provided, for example, via an internet link to the cloud 190, or through other dedicated hosts (not shown).

The system 100 confirms service fulfillment by providing fulfillment status with details as well as by providing contact information for questions/issues through activation of the service fulfillment module 122. The module 122 will also handle survey creation and automated survey initiation based on administrator provided criteria.

The compensation and benefits administration module 124 stores participant compensation details such as salary, bonus, performance goals, relative value units (RVU), and other information as it applies, along with FAQs and links and/or contact number, forms and chat links for the system's service liaison. Through module 124, a user can access relevant information by clicking on a link, or initiating contact with the service liaison through the service request module 120. The compensation and benefits administration module 124 can also manage and present to the user a compensation calculator based on various imputed data, such as the RVU. RVU functionality will be described in more detail in reference to FIG. 23.

The compensation and benefits administration module 124 also provides a user with benefits administration storage and management enabling the system 100 to store participant qualified benefit and supplemental benefit information along with FAQs and links to relevant benefits data sources through the service request module 120. The benefits administration module 124 enables the user or the administrator to access benefits information by clicking on a link, or initiating contact with a service liaison as previously described. The benefits module will also provide on the dashboard module 126 (as shown in more detail in FIG. 23) a benefits calculator.

The system 100 further includes a document vault module 125 where users are able to upload and retrieve documents such as wills, legal contracts, and other information in a secure location. The system 100 will also provide the user with information about vault module functionality, and contact data. The participant will be able to initiate contact with the service liaison via the service request module as previously described.

The RSS/ATOM news feed module 128 provides feeds within the system 100 portal. The module includes a default RSS/ATOM news feed function and allows for a user to customize their feeds. An E-mail and calendar synchronization module 130 provides synchronization with a data base or external resource which in turn allows the system 100 to provide the user with functions such as setting and modifying events as well as drafting, sending, viewing and deleting e-mails.

The RSS/ATOM news feed module 128 works in close conjunction with the secure messaging module 150. The module 150 enables users to participate, communicate and collaborate in a secure setting, in effect, creating a “lounge” environment for end users. Users can connect with peers, communicate with leadership and message substantively to support, for example, a team-based environment. In certain fields, such as medicine, the secure messaging enables doctors, for example to collaboratively diagnose a patient. In other team based work environments, such as law, a team of lawyers are able to remain on the same secure channel to collaborate on documents, strategies and evidence.

A multi-device access module 132 provides the system 100 with the ability to manage accessibility from multiple devices such as smartphones, IPad, notebooks, tablets, smart watches, desktop computers, communications paraphernalia (e.g., Google glasses) and laptop computers. The module 132 can utilize, for example, a standard browser view, specific browser views or a customized application.

Another feature of the first embodiment system 100 is an applications (apps) module 140 which provides a number of functions handled by an applications provider process (not shown). The app module will provide some basic information and FAQs about the apps, along with a link to each app's respective website or other relevant contact information. The end user is thereby able to access information by clicking on website links or by initiating some other form of contact, such as email or chat request.

The system 100 provides a rewards program for specific activities and/or based on arrangements with certain third party service providers. For example, an end-user may receive rewards for achieving usage levels of the system. Another example is if an end-user utilizes a tax service to prepare his or her taxes, that individual can receive a discount for next year's tax services, or some form of point rewards.

The module 170 coordinates and distributes an activity stream of data comprising all forms of data content to end-user dashboards. The module 170 personalizes the activities stream by applying filters to incoming data, such as the RSS/ATOM news feeds 128, and organizes content based on the specialized interests of employees, and by data-type. Data such as research, news, are distributed to end users. The module 170 also allows users to configure their activity streams so they can personalize one or more channels by topic, group, hobby or any other desired configuration.

The system 100 can be implemented on a single server computer or on multiple servers interconnected through communications links 150, 190 and 195. The present invention also can be applied to a cloud-based platform, where all functionality is remotely hosted. Any computers or servers known in the art can be used in this first embodiment. Data storage for system 100 can be accomplished through the knowledge center 116, or via cloud storage capabilities 190 as is well known in the art.

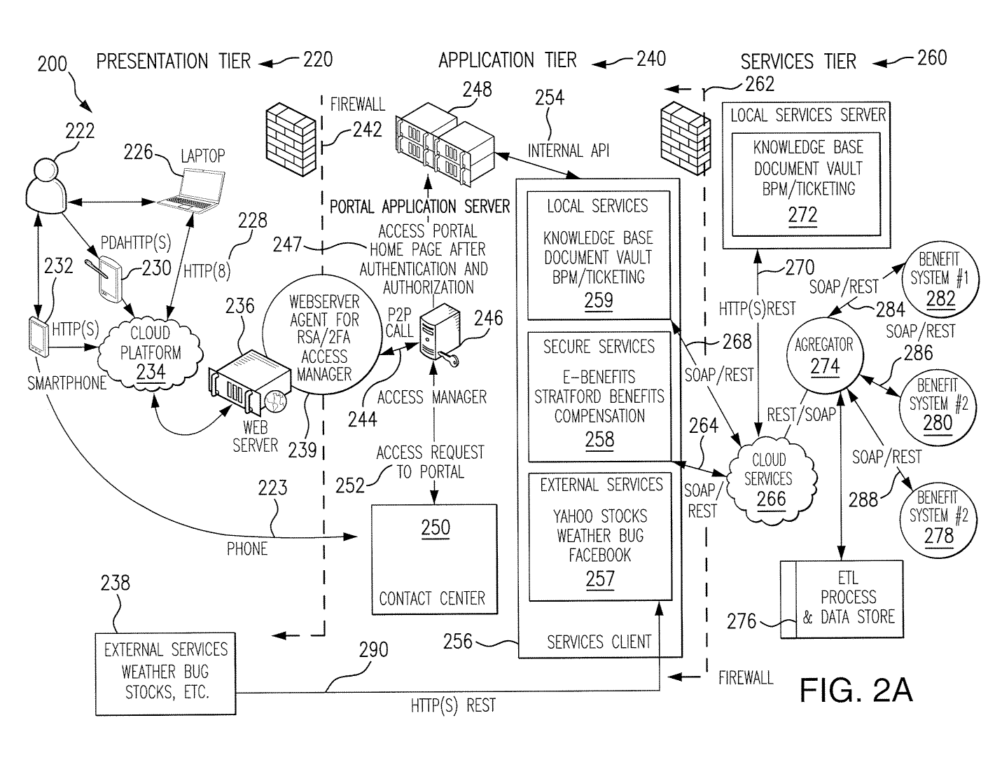

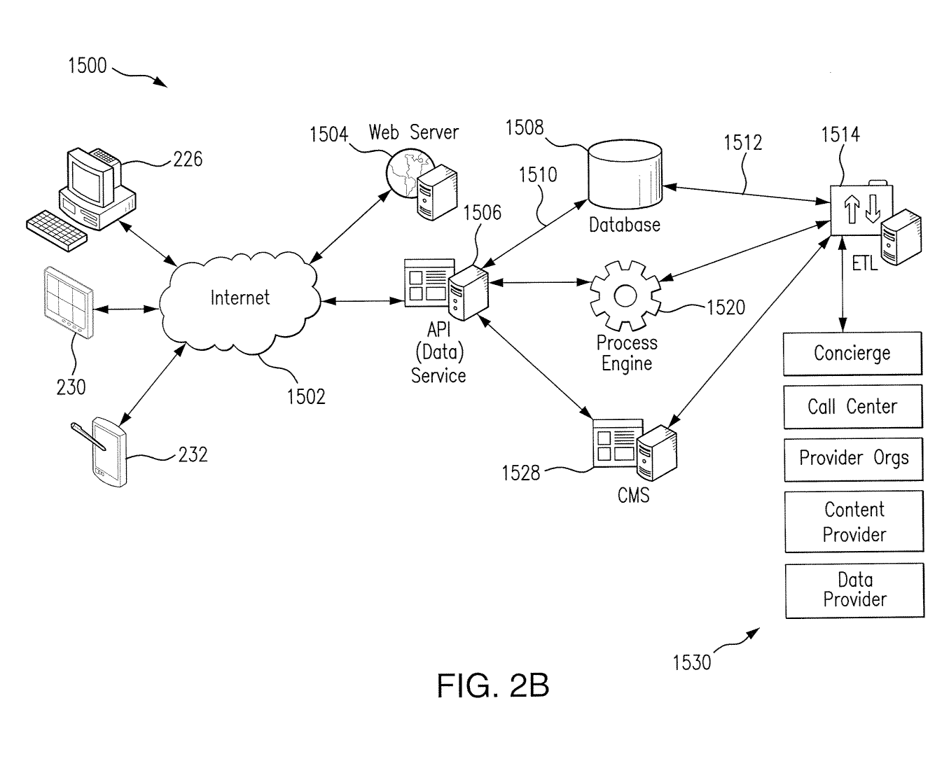

FIG. 2a is a hardware block diagram of an alternative embodiment 200 of the architecture for the present system. The system 200 is divided into three tiers. The presentation tier 220 has the end user, such as a physician 222 who interacts with system 200. User 222 can interact in a number of ways: through a cloud connection 234, a smart phone 232 or by other means as described in more detail below. Through these connections, the user interfaces with a front end server 236 to keep security for the application tier 240. In essence, therefore, the presentation tier 220 is the front door to the system 200. The web server 236 in turn, hands the user off to the access manager server 246. The access manager server will in turn decide “who you are” and “what you have access to” and then route the user ticket to more sensitive tiers, such as the services tier 260, or reject the inquiry for security and/or privacy issues.

Specifically, if a user is not recognized, they are kicked out or not given a key to the system. Once accepted, however, there are then two paths the user can follow: the path 247 which leads to the portal application server 248 which decides what services the user is going to receive. No end user therefore has direct access to the data. They instead obtain it through the presentation tier 220.

The portal application server 248 is dictated by the services offered the services tier 260. There are three different app models in the services client 256 that tie into the services tier 260. Specifically services 259 are local and are in the service provider's data chart. Secure services 258 are obtained from third parties. External services 257 comprise third party push services to the system 200. For example, RSS/ATOM feed data is pushed from the Internet into server 248 via the services layer 260.

The services tier 260 includes a data aggregator 274. The services tier requires access to the cloud 266. For example, the user needs to obtain a spending plan. That user's credentials flow through the access server 246 and then are passed through the portal application server 248 to determine which services tier provides data. The system 200 can, for example, use a service oriented access model or a standard representational state transfer (REST) format for access control. Simple Object Access Protocol (SOAP) can also, for example, be deployed in this embodiment at the firewall 252 connection points. The benefits aggregator 274 is an engine that serves as a hub for all third party data; the hub receives the data stream, aggregates the data, normalizes the data for the system 200 protocol and then pushes it through the other tiers to the presentation tier 220 and then to the user dashboard.

Specifically, the presentation layer consists of an end user 222 who accesses and interacts with system 200 through multiple devices including smartphone 232, a tablet device 230, a laptop computer 226 or desktop unit 250, the latter of which is typically located behind the firewall 242. In this second embodiment 200, the devices interact through a cloud platform 234 with the web server 236. However, as noted previously with respect to FIG. 1, any connection between an end user 222 and the web server 236 can be used. Ultimately, at some point there needs to be an internet connection.

The web server 236 comprises both hardware and software that helps deliver web content that is accessed through the Internet 234. Regardless of the devices, the HTTP protocol is used to route data to the server 236. Any known LAN, WAN or 802.11 platform can deploy HTTP.

The webserver 236 connects to the access manager 246 using public key two-form authentication 239 (known as “something you have” and “something you know” protocol). Once authenticated, the user 222 is passed via a peer to peer pipeline 244 to the access manager server 246. The access manager 246 is a dedicated server for routing incoming calls in pipeline 244 with encryption keys for the system 200. All of the end users will typically go through to the server 248. The other branch of the access manager server 246 connects to the contact center 250 which represents internal desktop communications-typically staffed by employees of the system provider. Access can also be by phone 223 to the contact center 250, which then acts as a proxy for the end-user 222 via connection 252.

In the services tier 260, the knowledge base 272 is used by internal users 250 for servicing a customer 222. Typically, the knowledge base 272's data is available to users within the system. Different users will see different knowledge content. The knowledge base 272 operates in a manner equivalent to an access controlled Wiki. This architecture is important for benefits/plan administrators, call centers, etc. The knowledge center is therefore not the repository for the data aggregator.

The knowledge base provides a document vault service which allows an end user 222 to directly store documents securely in knowledge base 272. The business processing management (“BPM”) component of knowledge base 272 comprises business process management data, which defines the processing rules for the workflow of system 200 relating to customer support. Thus, a contact center 250 user will have workflow rules from the BPM 272 to handle issues and inquiries based on a ticket tied to information processing needs.

The aggregator 274 will obtain third party information from sources 278, 280 and 282 and then aggregate the obtained data based on system needs. The external transfer and load process performs the external transfer and load functions 276 for the aggregated data 274 in the same manner previously described in connection with FIG. 1.

FIG. 2b is a hardware diagram of another embodiment 1500 of the present invention.

As shown, a user can interact through the internet via a number of devices including a computer 226, a tablet 230 and/or a smartphone 232. All of these devices are connected through conventionally known Internet services and infrastructure 1502.

A webserver 1504 is utilized to help deliver web content accessed through the Internet 1502. An application programming interface (API) data service 1506 is designed to receive and provide data from the Web. The API is a set of programming instructions and standards for accessing the Web (or a web tool). The architecture also includes a database technology 1508. The present invention database 1508 uses a technology called MongoDB which is a cross-platform document oriented database system. MongoDB utilizes a JavaScript ObjectNotation (JSON) format for stored documents, so that the integration of data in certain applications is speedier. In use, data received from third parties along path 1512 will likely come in as a tab delimited flat file and will therefore be parsed into database 1508. The parsing function is performed by the ETL (extract, transform, and load) platform 1514.

The process engine 1520 manages and executes events and acts on documents according to the defined processes, such as the sequence of steps which compose a healthcare data analysis or the steps necessary to onboard a new employee, such as a physician. The engine ISO has three functions: (i) verification of current status, which checks whether a command is valid in executing a task; (ii) determining the authority of users, which checks if the current user is permitted to execute a given task and (iii) executing a condition script step. This third step occurs after the process engine 1520 passes the previous two steps. If so, the engine begins to evaluate conditions script in which the two processes are carried out. If a condition is true, the workflow engine executes the task. Once execution is successfully completed, the engine returns the successful result.

The content management system (CMS) 1528 provides publishing, editing and content modifying functionality as well content maintenance from a central interface. In particular, the embodiment uses the CMS for content management on the platform except for content feeds from third parties. Customers can have direct access to the CMS 1528 in order to manage their personal content.

As noted previously, the ETL 1512 includes three processes to manage third party data fees: extracting data from connected outside sources and transforming the extracted third party content to fit operational needs, for example quality units for certain type employees. The transformed data is then loaded into the operational data storage device 1508.

The third party data resources 1530 include the concierge services, a call center, provider organizations, miscellaneous content providers, third party data providers, to name a few.

The following figures describe functions that can be executed by computers in either embodiment previously set forth in FIGS. 1-2(a)-(b).

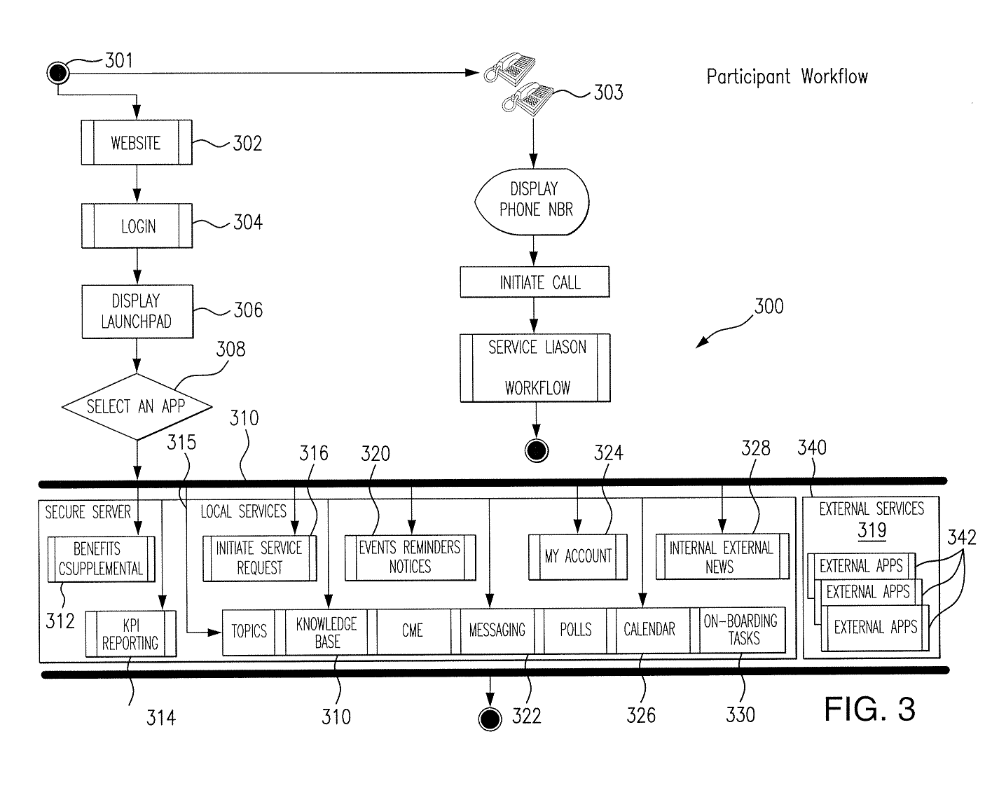

Referring now to FIG. 3, a participant workflow 300 shows an overview that identifies how users will interact with either system 100, 200 or 1500. At start point 301 such as a phone call 303 or user access to the Internet website 302, the user logs in at step 304 and enters a display launch pad (e.g. home page) 306 where the user will then select the appropriate application 308 through their dashboard.

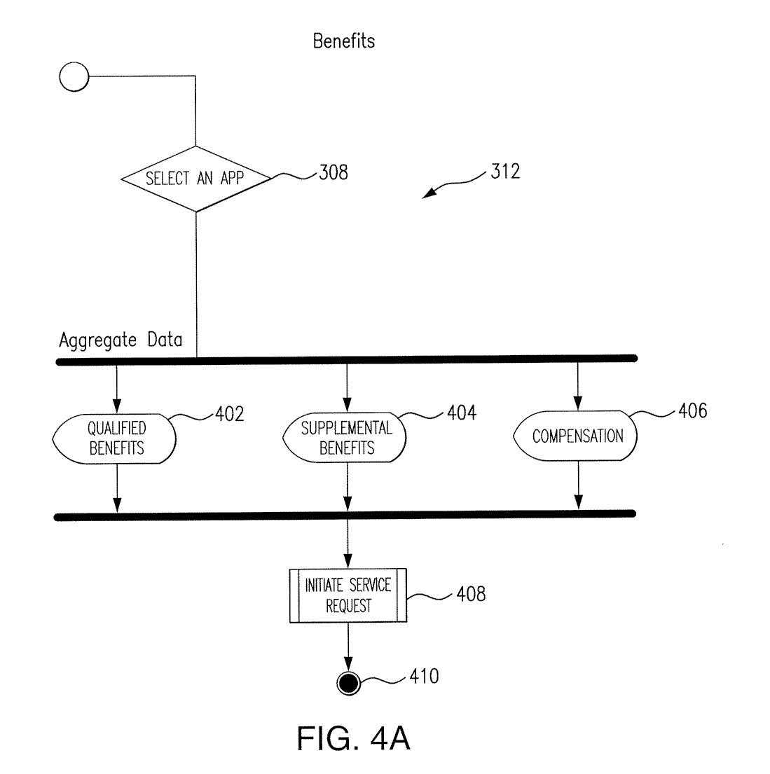

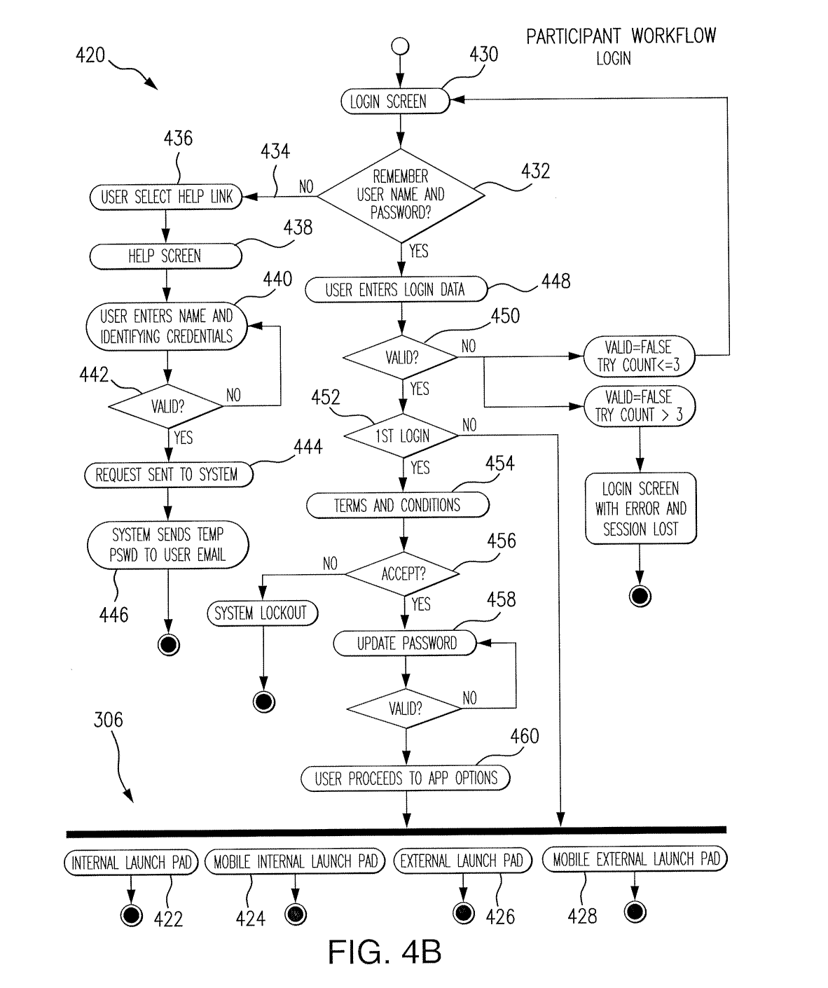

The sub-processes 310 are then engaged. The two services are offered such as secure local services 315, and external services 319 which correspond, for example, to modules 259, 258 and 257 respectively shown in FIG. 2a. The workflow for the system 312 and the other functions 316-342 in services layer 310 are shown in FIGS. 4a-22.

As shown in FIG. 4a, the select an app for benefits step is broken out in the launch pad 306. There are three benefits posted: qualified 402 (which requires approval) benefits, supplemental (non-qualified) benefits 404, and the user's compensation package 406. If there is a process needed with the benefits package, e.g. adding a spouse, then the service request 408 is initiated as will be described further below.

FIG. 4b illustrates another embodiment of the workflow for participant login 420 for the launch pad 306. As illustrated, launch pad 306 can comprise an internal launch pad device 422, a mobile internal launch pad 424, an external launch pad 426 and/or a mobile external launch pad 428.

The workflow initiates at the launch pad screen 430 where the user enters a name and password which is tested at step 432. If the system does not remember the user's login data, then an appropriate sign-in help line is provided 438 and the user is prompted to enter identifying credentials and name at step 440. The entered data's validity is then checked at 442 and once the credentials are accepted, a temporary password is sent to the user by E-mail (steps 444 and 446).

Once the login data is accepted at step 450, the system checks whether or not this is the first time the user has logged in at 452. If the condition is “yes”, then the license and other system terms and conditions are presented for user acceptance at steps 454 and 456. Upon acceptance, the user password is updated and the app options become available at step 460.

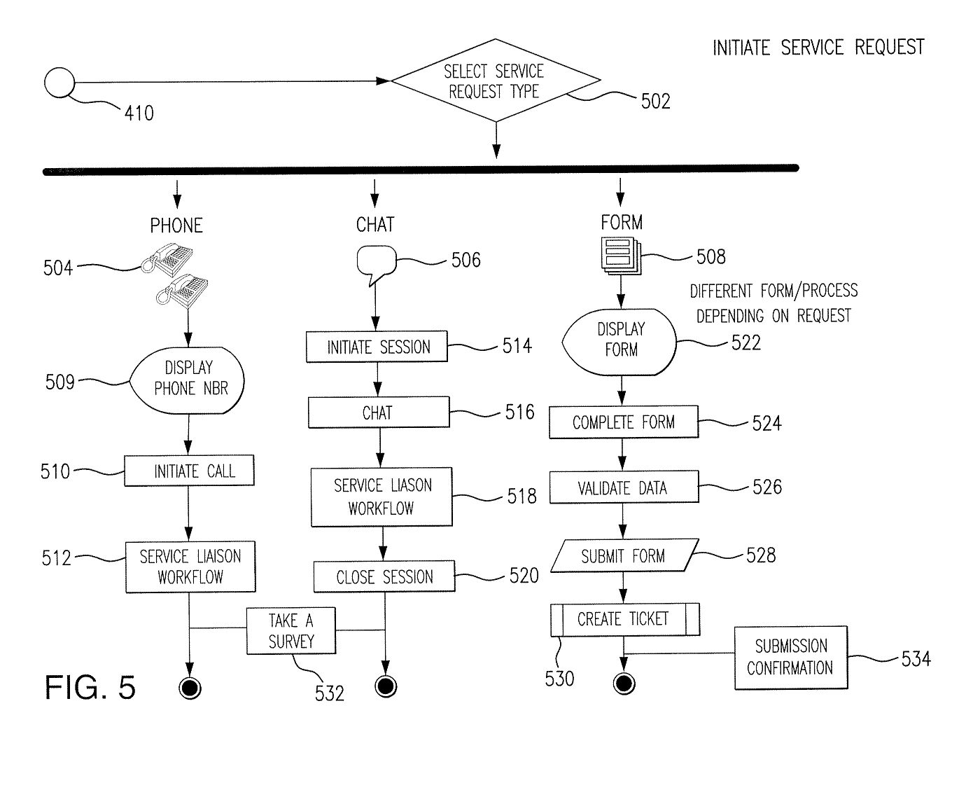

The service request 408 is initiated at step 410 as shown in FIG. 5. At initiation, the user 222 selects a service request type at step 502. The request is then communicated either via phone 504, chat (SMS) 506, or in paper form 508. The service requests ultimately results in either a service liaison workflow 518, or in a system ticket 530, which is coordinated via the database module 272 as described, for example, in connection with FIG. 2a.

The sub-processes in FIG. 5 for service requests are as follows: For telephone initiated requests 504, the user's phone number is displayed at step 509, and the call is processed at a call center 512 to enter the service liaison workflow 518 via the proxy connection, for example, at center 250 as described in FIG. 2. For a chat request, 506, the system responds to an initiated chat request 514, and 516 whereupon a ticket is created at step 518 according to the BPM rules and the chat session is then closed at step 520. The paper flow consists of displaying a system form generated by the BPM rules 522, completing the form 524, validating the user data 526, submitting the form via proxy connection exemplified at 250 in FIG. 2a and creating a system processing ticket 530 as previously described. The submission confirmation then occurs at step 530

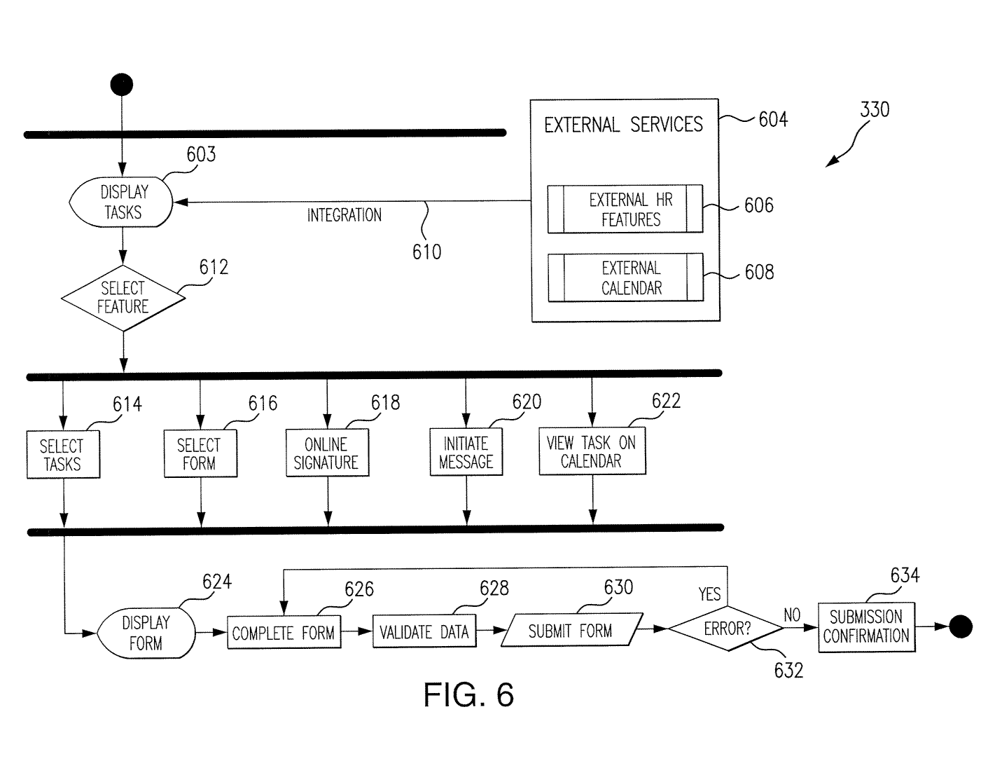

Referring to FIG. 6, the onboarding tasks 330 workflow (function illustrated in FIG. 3) is provided. At step 603, the onboarding tasks are displayed on the launch pad. The onboarding tasks can incorporate internal information/services as well as external services 604. Those services include external HR features 606 and an external calendar feature 608. Both internal and external features are integrated via process flow 610. The user is then prompted at step 612 to select an internal or external feature whereupon they will be prompted or given information to either select particular on-boarding tasks 614, fill out a selected form 616, provide a signature 618, initiate an on-boarding related message 620 and/or view the on-boarding task on the calendar function 622.

If the selected task 614 involves form completion, then steps 624-634 represent the form display, complete, validate and submission steps involved are performed as described previously.

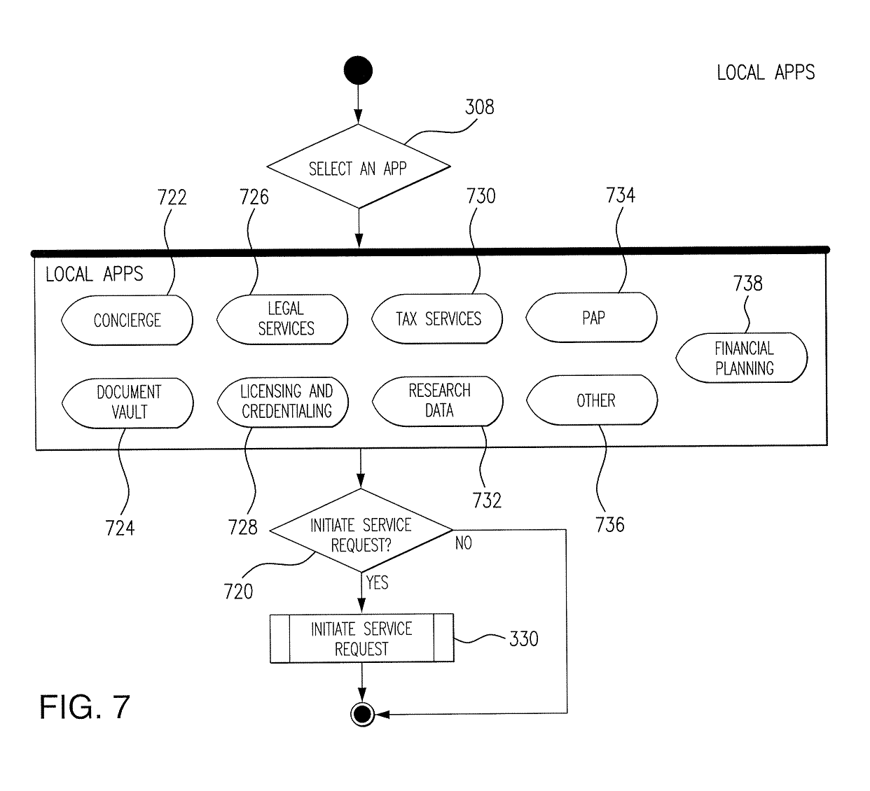

Referring to FIG. 7, the select app point 308 enables a user to select an app through their dashboard as shown separately in FIG. 23. The apps available to the user include concierge services 722, the document vault service function 724, the legal services function 726, the licensing and credentialing function 728, tax services 730, research data 732, a PAP function 734 and financial planning services 738. If there is a problem inside an app, the user 222 will initiate a service request 720 to obtain system assistance (FIG. 5), or obtain help menu information, if available.

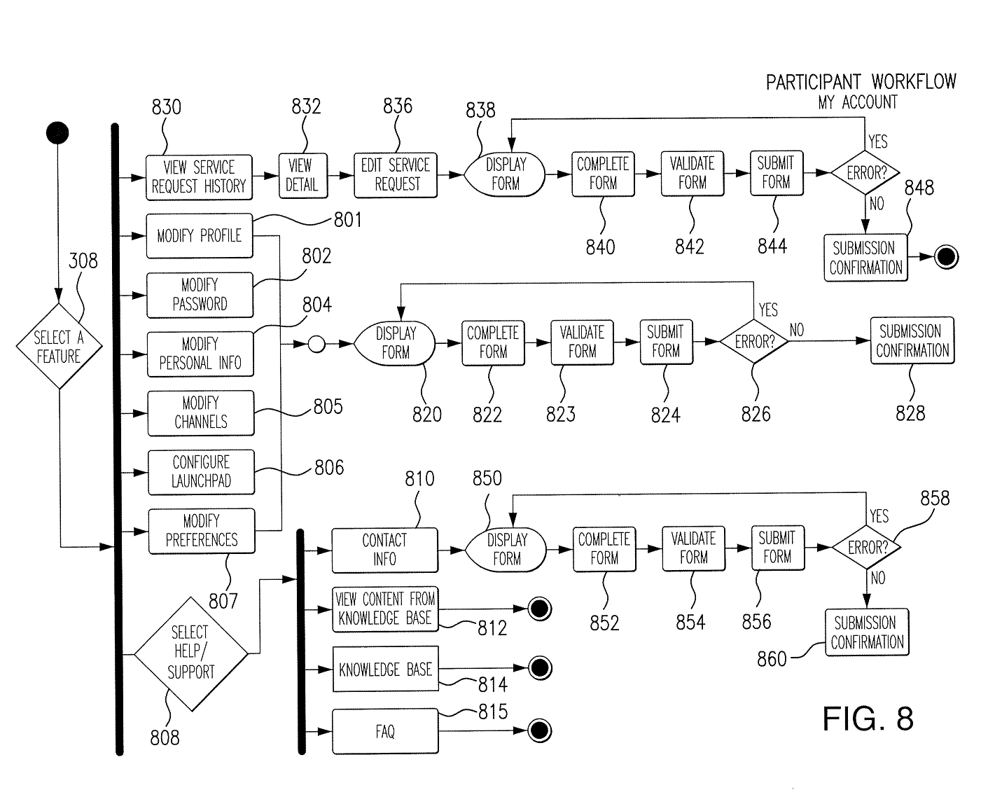

The account FIG. 8 shows how a user 222 updates and manages profile information as well as services the user needs from the system. Also if a user 222 leaves the employer, they can port their benefits or other communications or profile information with them. For example, healthcare benefits under COBRA would remain active and live for the end user 222 after they leave their employer. Other record-keeping needs such as, for example, old pay stubs for tax reporting purposes would also remain available through this feature. Manage profile functions include modifying password 802, modifying personal information 804, modifying channels available on the user dashboard 805, configuring the launch pad 806, modifying preferences such as user activities 807, and modifying security questions 806.

The modifying steps further include displaying the appropriate form to modify, 820, completing the form 822, validating the form 823, submitting the form through, for example, the proxy connection 250 at step 824, repeating steps if there is a system detected error based on the BPM rules 826 and then receiving system confirmation 828 of a completed submission.

The modify step 807 allows the user 222 to add information to enable them to gain access to apps not universally available. For example, adoption services can be added to user 222 profile, and they can pay for it themselves. Most employer benefits do not offer the ability to personalize a benefits portfolio for the end user 222 with non-standard benefits offerings. However, the aggregation and availability of these alternative or supplemental benefits are powerful engagement features that enable each employee 222 to personalize their data to fit their needs.

The options available to the user via step 808 include dashboard features such as contact information 810, content from the knowledge base 812, direct access to the knowledge base functions (e.g. data vault) 814, and a resource for FAQs 816. The contact information includes form submission and completion steps 850-860 that function similarly to steps 820-828.

The user 222 can deploy the service history module 830 to review service request history and edit service requests at step 836 as well as submit new or replacement service request forms at steps 838-848.

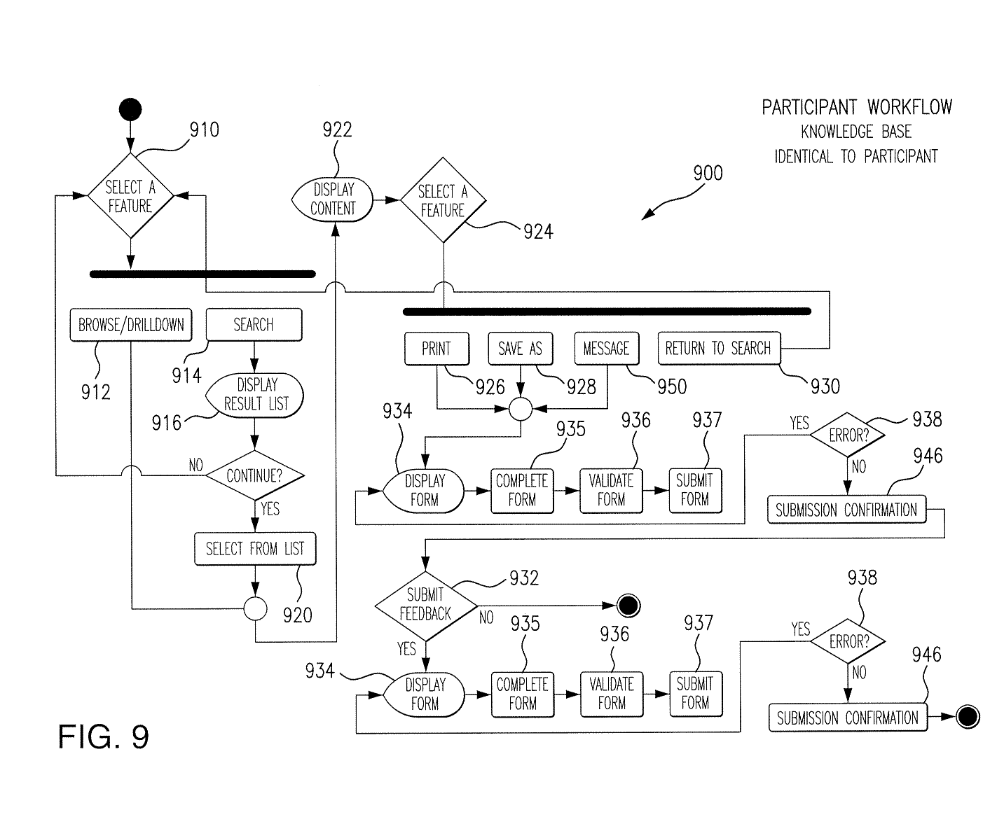

FIG. 9 illustrates the flow steps 900 regarding how the user 222 interacts with the knowledge base 272. At step 910, the user selects the knowledge base search selection feature 910 from which several search options are available: a browse/drill down function 912 or a search feature 914. After the search 914 is performed, the user can display the result list at step 916, and then can select a specific item from the list 920. The user who selected an item from the list, or the user that chose the browse/drilldown options can then display the content 922 and select 924 to either print the result 926, save the result 928 send a message 950 or return to do another search 930. The user 222 can also submit feedback to the system administrator by completing and submitting a feedback form through steps 934-946 in a similar manner described in steps 820-828 (FIG. 8).

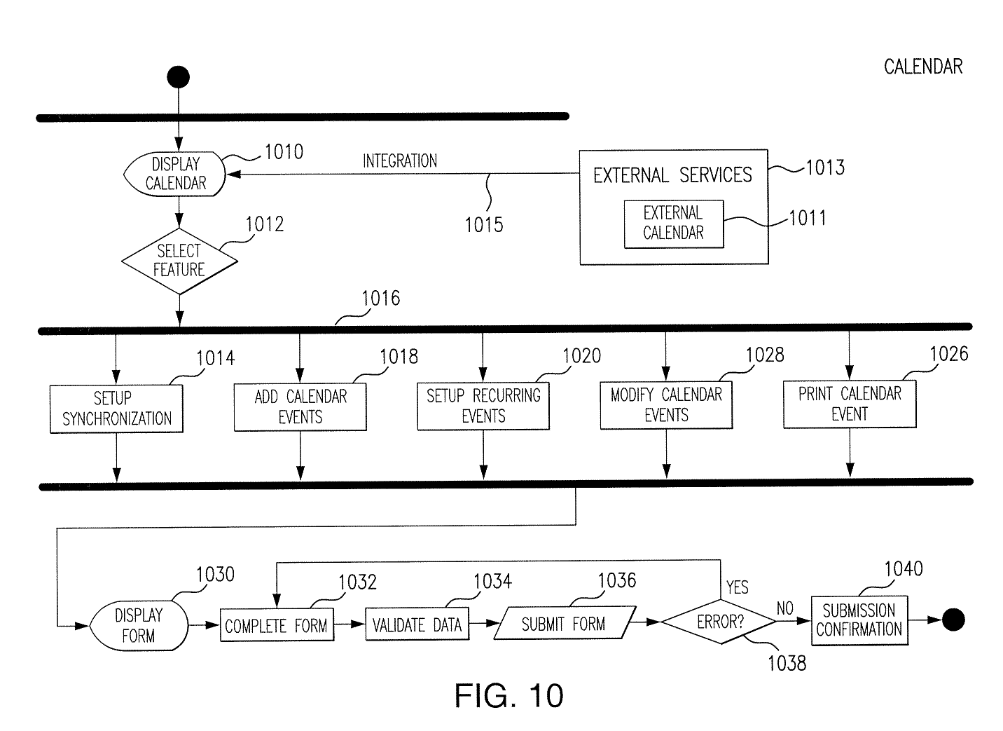

FIG. 10 shows the calendar feature 1010. As shown the user accesses the calendar display at step 1010, where they can then select among a number of features 1012. The display can incorporate an external calendar 1011 available on the external services 1013 that are integrated 1015 into the platform. Those features include setting up a synchronization routine 1014 with the user's other data (e.g. emails, contact list, benefits), adding events to the calendar 1018, setting up a recurring events function 1020, modifying existing calendar events 1028 and printing those events 1026. The end user can also provide feedback to the system through completing, validating and submitting a form in steps 1030-1040 in the manner previously described.

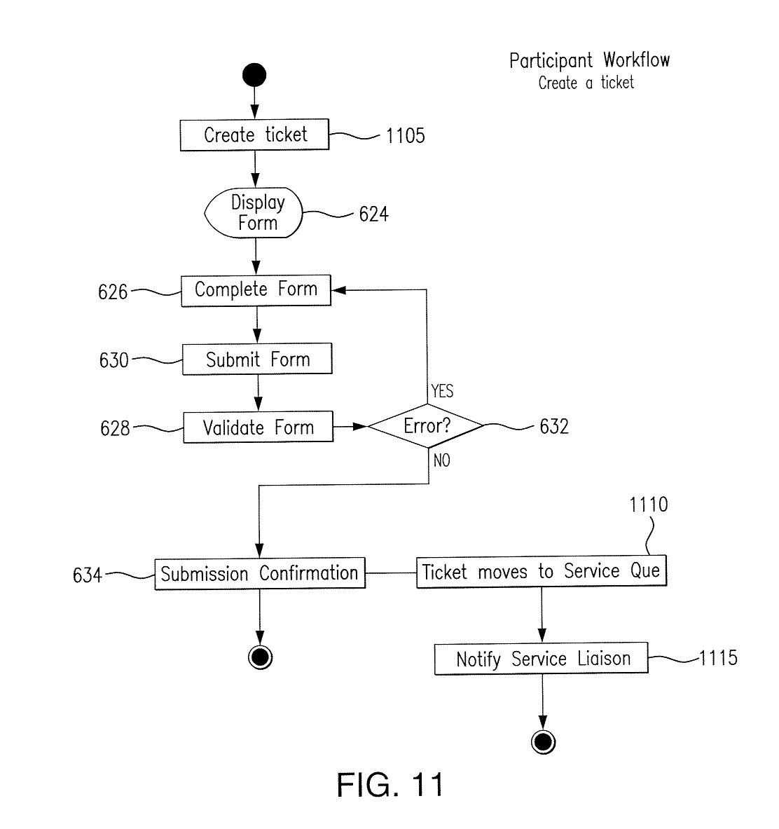

FIG. 11 is a workflow diagram of the create ticket function 1105 of the present invention. The steps shown in this Figure are similar to the ticket/form creation steps 626-634 shown in conjunction with the on-boarding tasks in FIG. 6. Once the ticket form is completed, the ticket moves on to the service queue at step 1110. As a result, the system solution will provide the ability to facilitate service requests. The user will access the service from the application or by initiating contact with the service liaison via a phone call, form or online chat request. The system creates a unique service request number (the ticket) at step 1110 for ease of management. Both open and closed tickets are viewable by the participant as well as service liaisons at step 1115.

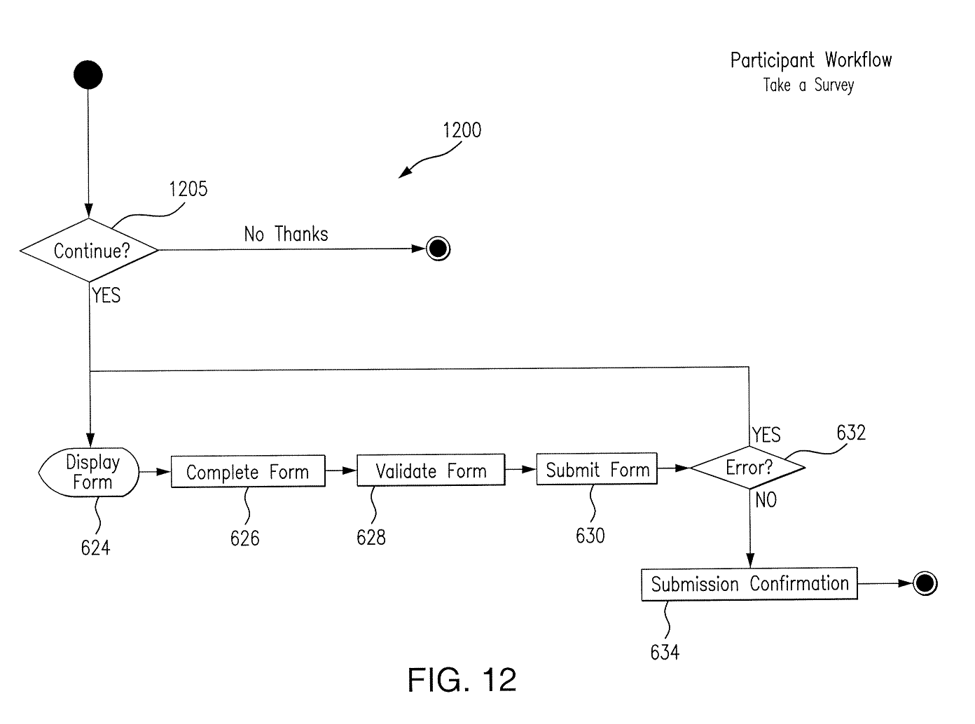

FIG. 12 shows the take a survey function 1200 that is available to users when, for example, a service request is initiated (See FIG. 5). The purpose of the survey function 1200 is to allow a provider organization to collect feedback from system participants. Participants will be prompted when the provider has a new survey to take a step 1205 and the requested completion date. Once the survey is taken using the same form completion steps 624-634 as described previously, the provider can view results in real-time of all respondents. At the provider's discretion, some surveys will be mandatory, some will be optional.

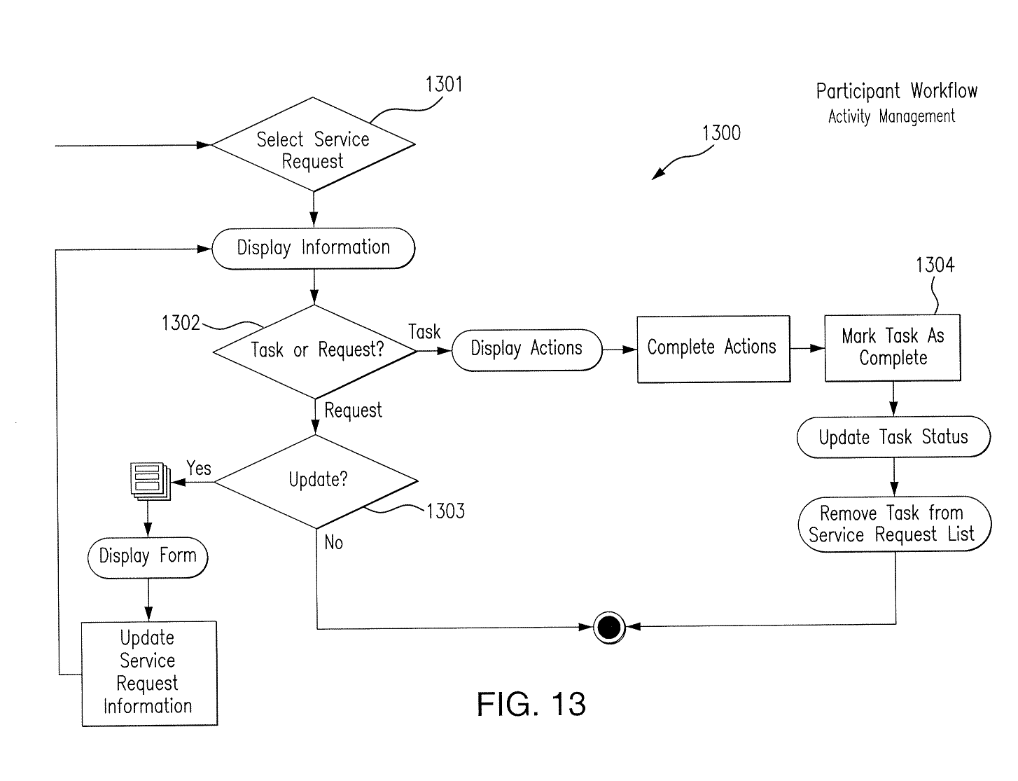

Referring now to FIG. 13, the participant flow chart is illustrated with respect to the activity management function 1300 of the present invention. The system provides the ability to request a service 1302 from the employer. The end-user will access the service request module from the system or by initiating contact with a call center via a phone call or Chat request. Service Requests are given a unique service request number to be referenced by the end-user, employer or call center and follow a workflow process beginning with create request 1302, update request 1303 and close request (complete) 1304. A transcript of open and closed requests (not shown) will be made available to end-users, the employer and call center that can be filtered by user or system defined criteria.

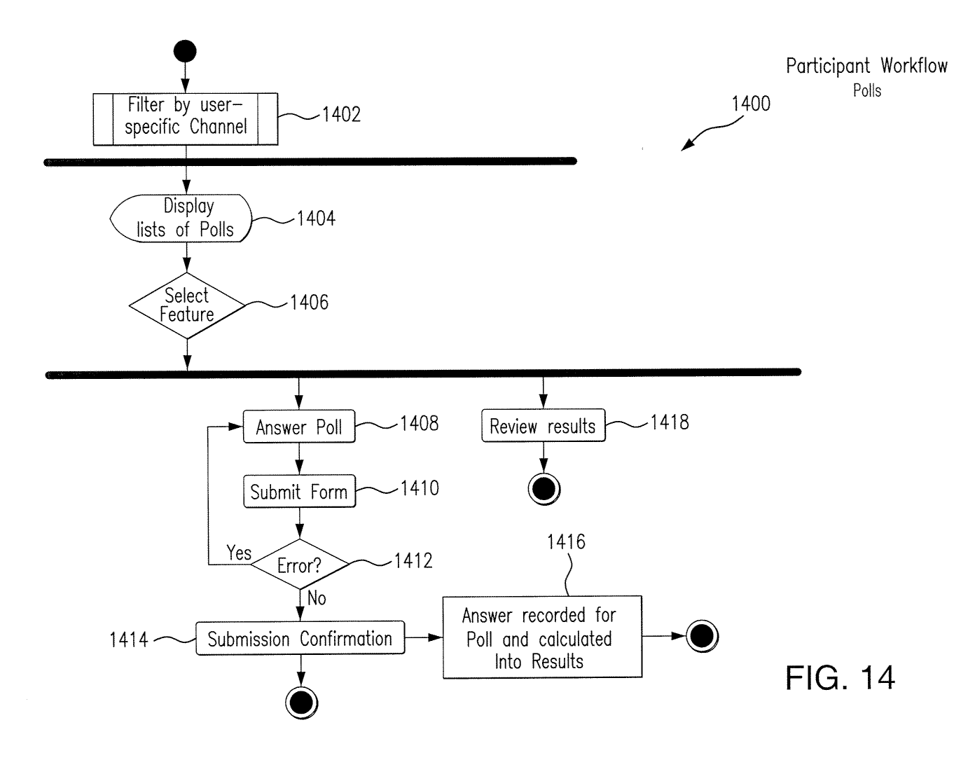

Referring now to FIG. 14, the participant flow chart is illustrated with respect to the polls function 1400 of the present invention. The present invention provides a poll function that allows a provider organization to collect feedback from their participants. Similar to surveys (FIG. 12), polls are simple one question surveys. Polls are presented to a user on a select user platform channel 1402 where the user can select a poll from a displayed list 1404. Once a poll feature is selected 1406, the user proceeds to provide his/her poll answer and submits the answer 1410 to the system. If an error in the answer is determined by the system 1412, the program loops back to re-engage the user at 1412. Otherwise, the poll answer gets submitted at 1414 and the poll results are automatically tabulated by the system 1416. The user also has the option to merely review poll results at step 1418 without having to answer the poll directly.

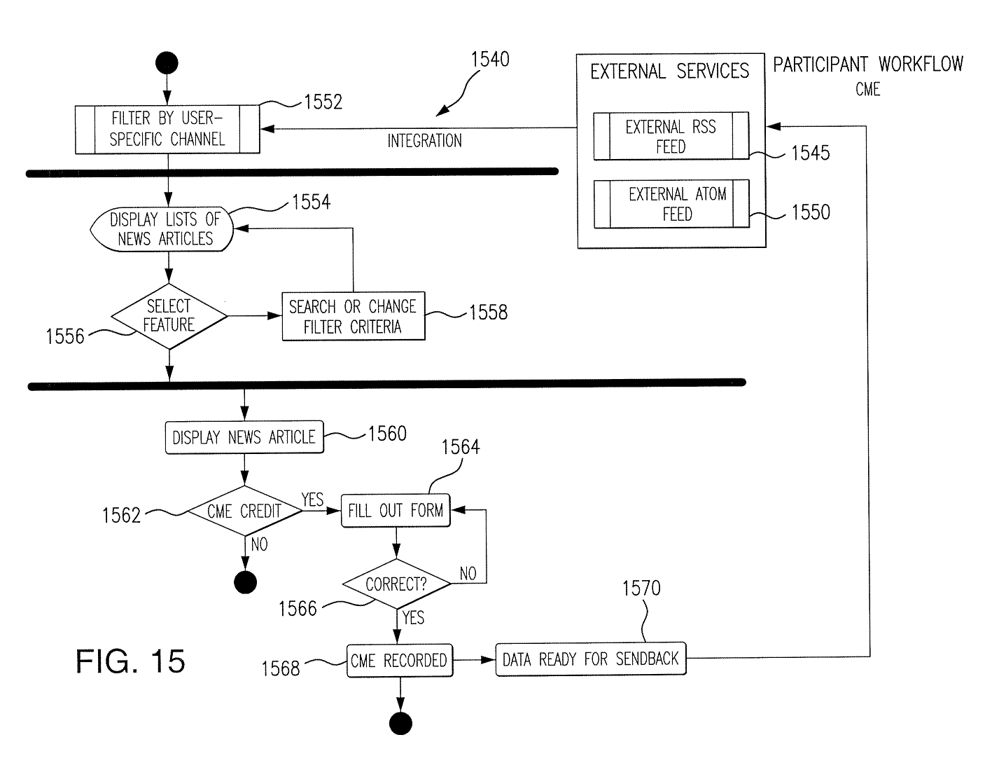

FIG. 15 is a flow chart of the CME function 1540. The system integrates and presents third-party content presented as RSS feeds 1545 or ATOM feeds 1550, such as continuing medical education (CME) content. However, the system can provide the user with any form of training content. Participants will have the option of reading content of interest, taking a brief quiz afterwards and upon successful completion receive accredited results or credits, such as a CME or CLE (continuing legal) credit. As show, the user selects the training, such as CME, on the appropriate channel. For example, if a doctor is a cardiologist, with a specialty in echo-cardiography, then he/she may choose a CME program on the echo-cardiography channel, rather than the general cardiology channel at step 1552. Once selected, then at step 1504 the platform will display lists that identify the desired CME course subject or other relevant training courses. Steps 1556 and 1558 reflect selection and further search functions available to the end user. The course will then be displayed at step 1560, and once viewing is completed, the user can request appropriate CME credit at 1562. The credit form is then made available on the system 1564, filled out and submitted at steps 1566-1580 to the external CME provider and medical or other third party accreditation organization.

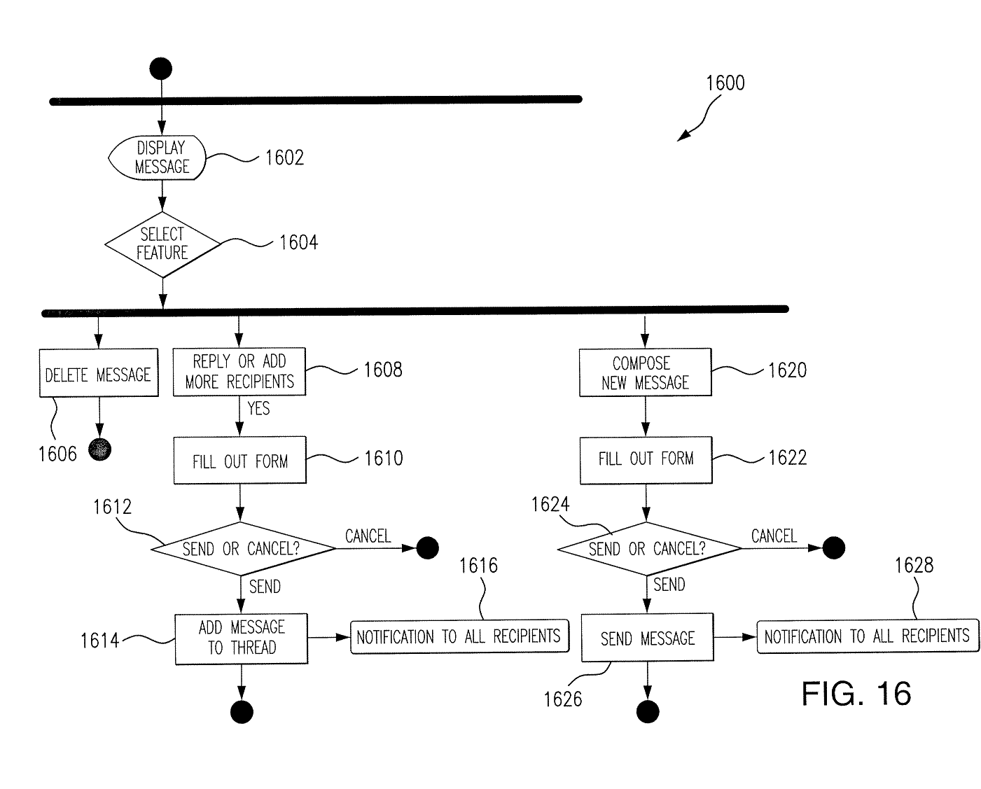

FIG. 16 illustrates the messaging functions of the present invention 1600. Overall, the system provides participants/management with the ability to send and receive secure electronic messages. Messages can be one-to-one or one-to-many in regards to recipients. Messages will allow for attachments. In use, once a user displays a message at 1602, he/she can choose from three options: delete the message 1606, reply to the message and/add more recipients 1608 or compose a new message 1620. If the reply option 1608 is selected, then the user will fill out the message form 1610, send or cancel the new message 1612 add the message to the message thread 1614 and notify all intended recipients, including newly added users 1616. Similar steps 1620-1626 are performed for composing a new message.

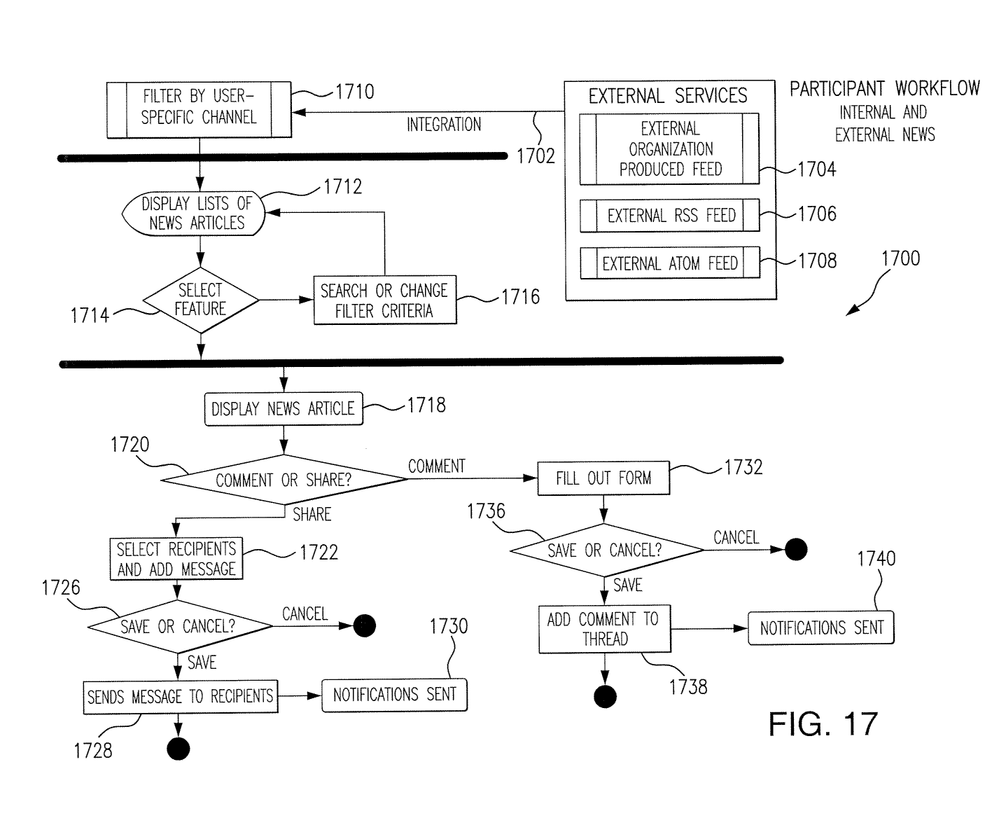

FIG. 17 illustrates the functions for internal and external news. The system has the ability to aggregate and present news from various sources including the provider organization, specialty areas, and general news. News content will be displayed as part of the activity stream, The news function 1700 starts with an integration 1702 which incorporates three third party news sources: external produced feed 1704, external RSS/ATOM feed 1706 and external ATOM feed 1708 (although more resources can be integrated, if needed). The integrated data is then filtered according to the user specified platform channel 1710 so that only news tied to the subject matter of the relevant user channels is displayed at 1712. The user then has the ability to select, search and open the desired news feed at 1714, 1716 and 1718. Beyond passive reading, a user can take two actions 1720: share the article with permitted recipients at steps 1722-1730, or add comments to accompany the article at steps 1730-1740.

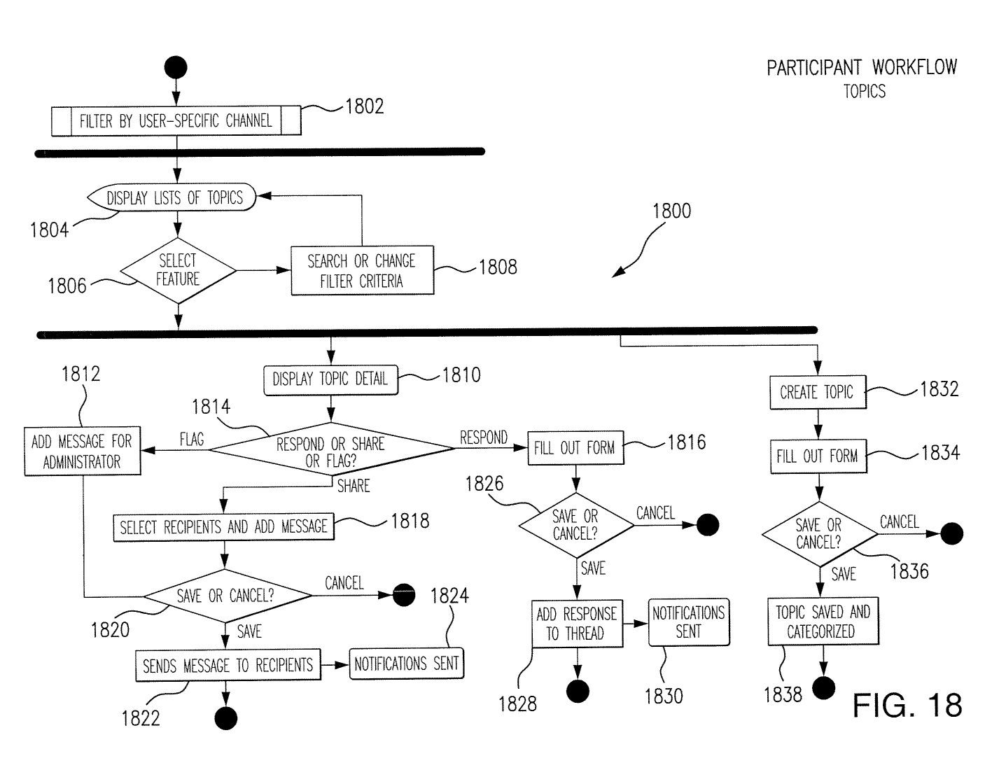

FIG. 18 illustrates the participant workflow for the topics functions 1800. The system solution allows users to post content and questions to the activity stream. Other participants can view postings, leave feedback, vote that they “like” the posting, forward or mark the posting as a favorite. At step 1804, the user displays a list of possible topics to choose from. They can then select a feature at step 1806 or search for other topics based on user identified filter criteria 1808. Once selected, the topic detail is displayed 1810. If the topic requires a response to a thread, then the user can select the response option 1816 and add his/her response to the topic thread at steps 1826 and 1828. The response notification is sent to the system at 1830. If there is an administrator message 1812, the user can send the message 1812 which gets routed for the intended recipient at 1822, 1824. The user can also simply share their chosen topic at step 1818. Additionally, the user can create their own topic at step 1832, and save and categorize it to the system at steps 1834-1838.

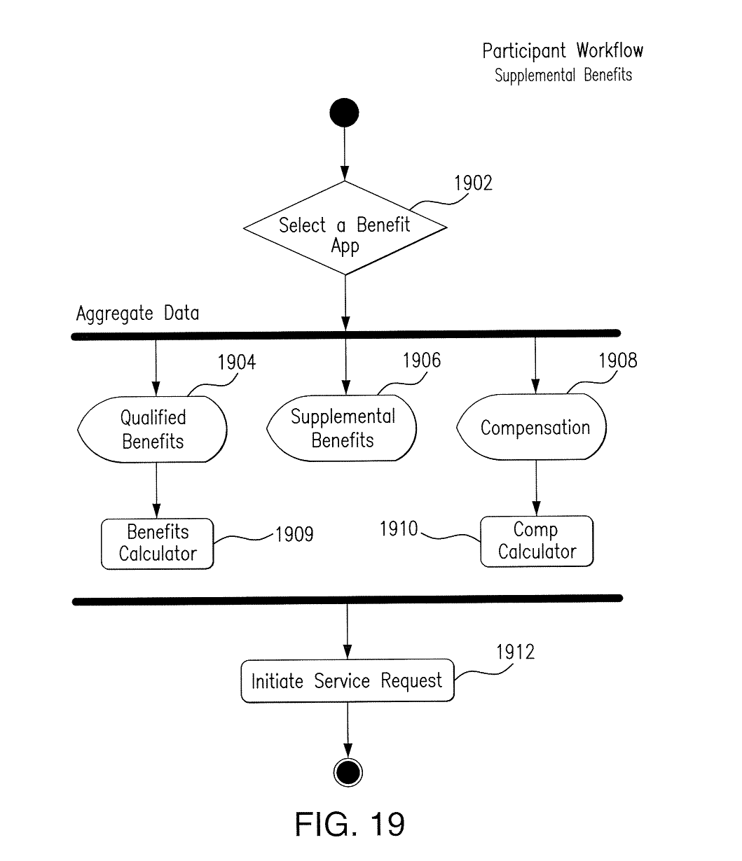

FIG. 19 is a flow chart of the supplemental benefits process flow 1900 according to the invention. The function 1900 provides a visual representation of the participant's supplemental employee benefit selections including plan descriptions, enrollment dates and compensation. Specific feature include a qualified benefits display option 1904 and benefits calculator function 1905. Supplemental benefits 1906 and compensation 1908 are also displayed and the employee can utilize a separate compensation calculator 1910. Service requests to the HR or outside providers is also available at step 1912.

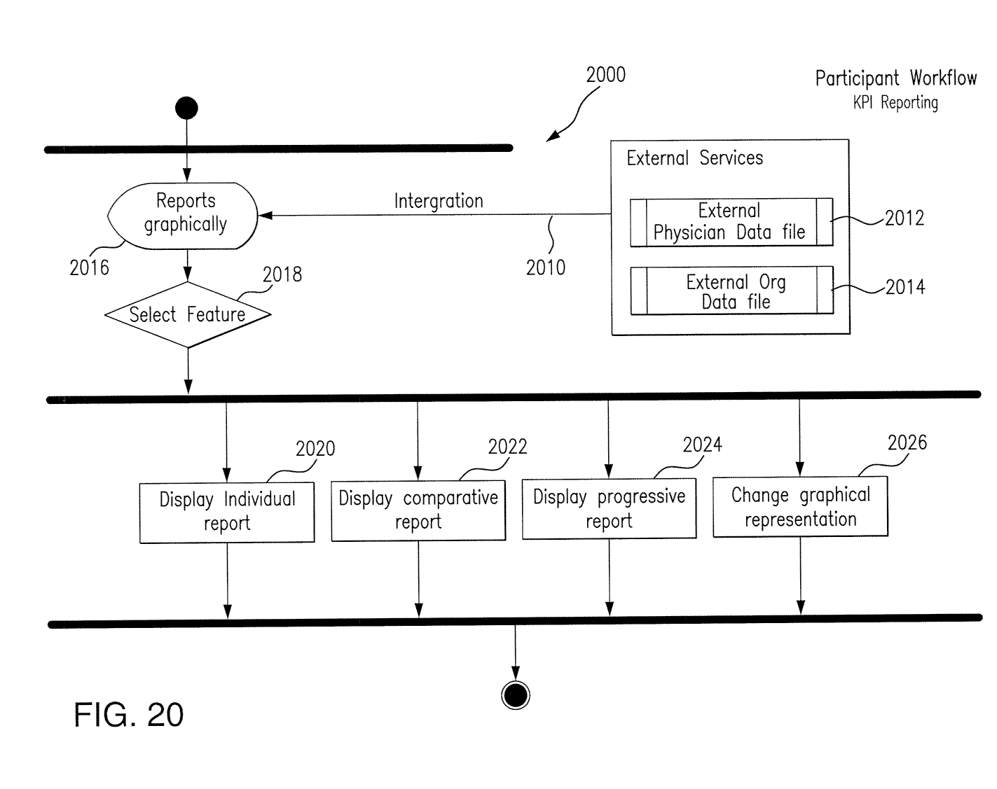

FIG. 20 illustrates the KPI reporting functions performed by the system 2000. The system provides a reporting module to track and report on Key Performance Indicators (KPIs). Operations, Application Maintenance Manager, Implementation Manager, Provider Org Contact and/or users will be able to build and export/print reports. Examples of reports include but are not limited to: productivity actual vs. budget, charge lag actual vs. budget, patient visits actual vs. budget, patient satisfaction and physician comp. To build reports, external information is integrated at step 2010. Examples of external data include external physician data, 2012, and external organization data files 2014. The report information is shown graphically to the end user 2016. The user can then select the feature 2018 in order to either produce an individual report 2020, a comparative report 2022, a progressive report 2024 or a graphical representation of the selected feature 2026.

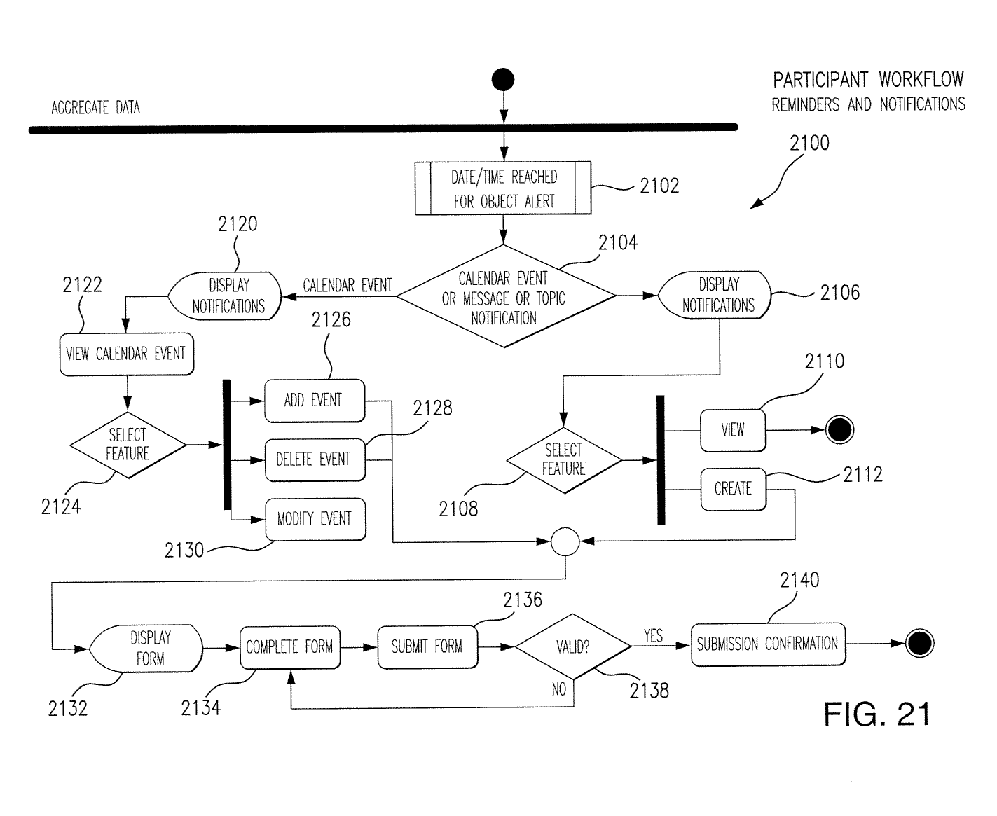

FIG. 21 is the flow chart of the reminders and notifications participant workflow 2100. System or user generated alerts and reminders are presented to the user for easy reference. A reminder could simply be a calendar event reminder, a reminder to re-enroll benefits, whereas notifications are generally activity updates (e.g. you have a new message). The process initiates at step 2102 where a date and/or time is reached for an object alert. A selection step for a calendar alert event or a topic notification is presented at step 2104. If the alert involves a topic event (e.g. news flash, or announcement of a new directive or article) the notification is displayed at 2106. The user can then choose to read the substantive material, such as the announced new directive in detail at steps 2108, 2110, or create their own a topic-based alert 2112. The create step 2112 opens up the alert form creation process 2132-2140 which is similar to the earlier described form creation steps (see e.g. FIG. 6).

If at step 2104 the alert involves a calendar reminder, then the reminder is displayed at step 2120 and the user is prompted to see the calendar event in detail at step 2122. The user is then prompted to select a reminder feature 2124 including adding an event 2126, deleting an event 2128 and modifying an event 2130. If the add event step 2126 is chosen, then the form creation process 2132-2140 is initiated.

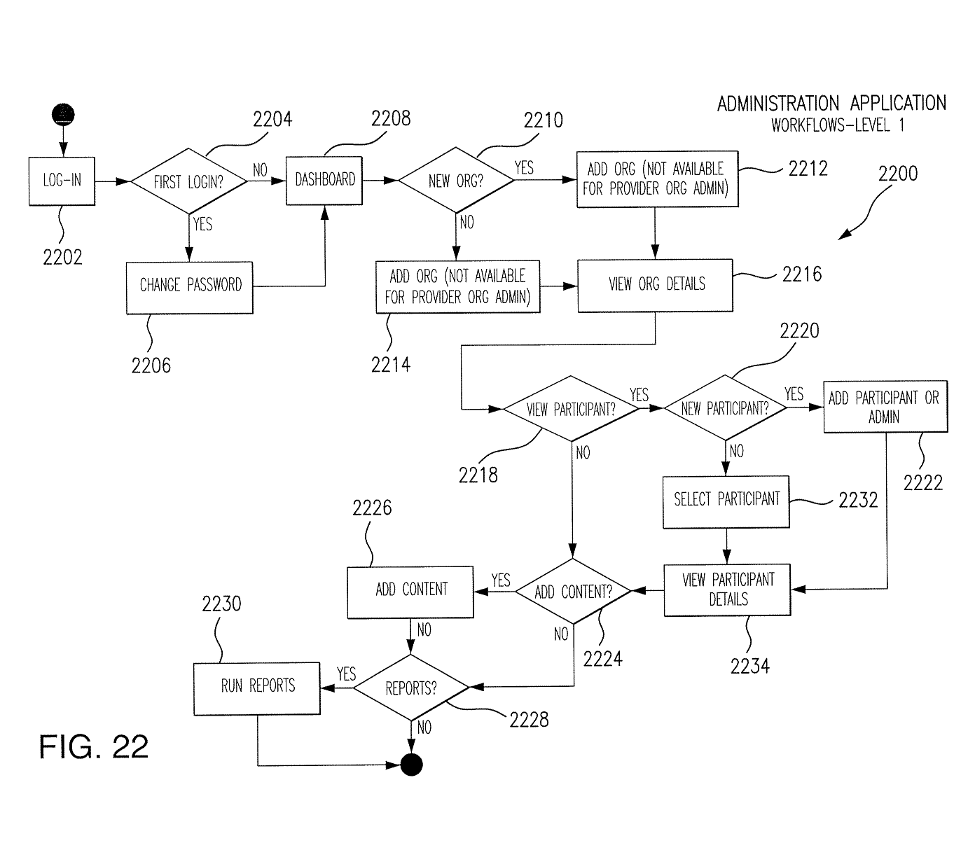

FIG. 22 illustrates the administration application workflows which are designed to manage organizations, and administrators using/accessing the system of the present invention. Like system users, organizations administrators are required to establish their own log-ins which are processed at steps 2202, 2204, 2206 in a manner similar to the previously described user login in (for example, see FIG. 4b). Once processed, the administrator/organization enters the system dashboard where they are queried whether or not they are a new organization to the system 2210. If they are new, then they are prompted to fill out new organization data at 2212. Otherwise, the organization selects their identity from a system list 2214 and views their profile information at 2216. The administrator can then view the participant at 2218 and either add content relevant to that participant at 2226, view reports relevant to the identified data/profile participant 2228 or add a new participant to the system 2220. Steps 2232, 2234 and 2230 are further steps to complete the above described processes.

FIG. 23 illustrates the user dashboard 2400 as previously described in FIGS. 1-23. As previously noted, the dashboard improves employer/employee communications by organizing on a single device activities relevant and customized for each user, regardless of source. The user can deploy multiple channels which reflect their interest. For example, for physicians, multiple customer controlled channels can be used with targeted content that is personalized to the user. On the left side of the platform display is an activity stream 2402 which presents to a user, administrator or organization content channels and topics such as research, polls, news and other content (e.g. benefits information). For example, if the user is a doctor, then they can receive medical news, search and retrieve relevant reference information, such as drug interaction information. The physician can also review relevant survey data such as peer reviews, nurse feedback or quick polls conducted by their hospital, medical society or other participating organizations. The channels can also foster collaboration. In a medical setting, for example, doctors and nurses can collaborate with peers in a social network type environment and provide direct feedback, such as messages, surveys, polls or other peer data. In addition the platform provides a series of functions and alerts 2404. The My Account function allows an end user to update their personal profile, system preferences and to log out. The Collaboration alerts indicate to an end-user when they have received an update to a topic they have posted. System alerts notify the end-user of system generated notifications such as appointment reminders. Message alerts notify and end-user that they have received. The search function is a site-wide search function of all aggregated content within the system applicable to the end-user.

The platform screen area 2406 shows the reporting, data aggregation and visualization part of the platform. The data reported in the area 2406 can, for example, include medical HCAHPS, RVU's, patient satisfaction data (qualitative and quantitative, and average appointment length information. Critical medical guideline and procedural data and information can also be displayed in a graphical or flow chart format so that EBM best practices are available to physician as needed (e.g. Patients with DM with LDL<100, Cervical cancer screenings per Guidelines, etc.).

A separate platform area provides the user with information from back-office systems. As shown, this display can, for example, include scorecard information such as physician, outpatient, ER and in-patient scorecards. Employee data such as HR benefits, compensation information can also be presented as previously described.

Area 2410 includes the area for scheduling, events, tasks and requests. For example, a user can easily manage his/her appointments, request information, announce or invite others to events and assign tasks to others through this portion of the platform. Business process optimization (BPO) data can also be included in this area such ads displaying a physician's relative value unit (RVU) so that they can easily assess how they are doing compared to other physicians.

Without further analysis, the foregoing will so fully reveal the teachings of the present invention that others can by applying current knowledge without undue experimentation can readily adapt it for various applications outside of the devices and software described in detail herein. While the invention has been described as embodied in a method and a system for medical personnel, it is not intended to be limited to the details shown since it can be applied to any industry. Moreover, various modifications and structural changes may be made without departing from the spirit of the present invention.

What is claimed is:

1. A computer system architecture for employer employee communications comprising:
a presentation tier including:
a user dashboard device for presenting customized activity streams, messaging, data visualization, back-office functions, scheduling, events and tasks in separate functional areas of the dashboard; and
a cloud platform for providing data and communications capability for the dashboard;
an application tier including:
a contact center for direct communication with a user;
an access manager for provide management of access to the system portal; and
a portal application server providing linkage and communications to local services, secure services and external services; and
a services tier including:
a cloud services layer for providing communication with the local services and the secure services in the application tier; and
an aggregator for aggregating communications and data from at least one benefits system and data storage unit.
